(19) United States
(12) Patent Application Publication
(10) Pub. No.: US 2022/0330587 A1
(43) Pub. Date: Oct. 20, 2022

(54) METHOD OF MANUFACTURING MARINATED TUNA FOR TUNA BURGER

(71) Applicant: HANSANG CO., LTD., Gwangju-si (KR)

(72) Inventor: Jeon Su HAN, Seongnam-si (KR)

(73) Assignee: HANSANG CO., LTD., Gwangju-si (KR)

(21) Appl. No.: 17/687,669

(22) Filed: Mar. 6, 2022

(30) Foreign Application Priority Data
Apr. 19, 2021 (KR) 10-2021-0050249

(51) Int. Cl. A23L 17/00; A23L 3/36; A23L 33/16

(52) U.S. Cl. CPC A23L 17/70; A23L 3/36; A23L 33/16

(57) ABSTRACT

Disclosed is a method of manufacturing marinated tuna for a tuna burger, and more particularly to a method of manufacturing marinated tuna for a tuna burger, in which tuna is covered or mixed with a marinating mixture for removing a fishy taste from the tuna and kept refrigerated, so that the unique flavor or smell and fishy taste of the tuner, which consumers do not like, can disappear while improving the texture of the tuna, thereby providing the tuna burger that the majority of ordinary consumers will like.

### CROSS-REFERENCE TO RELATED APPLICATION

This application claims priority from Korean Patent Application No. 10-2021-0050249, filed on Apr. 19, 2021 in the Korean Intellectual Property Office, the disclosure of which is incorporated herein by reference.

### BACKGROUND OF THE INVENTION

### (a) Field of the Invention

The disclosure relates to a method of manufacturing marinated tuna for a tuna burger, and more particularly to a method of manufacturing marinated tuna for a tuna burger, in which tuna is covered or mixed with a marinating mixture for removing a fishy taste from the tuna and kept refrigerated, so that the unique flavor or smell and fishy taste of the tuner, which consumers do not like, can disappear while improving the texture of the tuna, thereby providing the tuna burger that the majority of ordinary consumers will like.

### (b) Description of the Related Art

A conventional hamburger is made using beef, pork or other meats as they are in their original forms or mixed in an appropriate ratio, and includes simple ingredients such as meat with high fats and high calories, bread with carbohydrates, and some vegetables, thereby causing a lack and imbalance of nutrients. Thus, the harmfulness of the hamburger to consumers' health has been continuously raised, and therefore the hamburger has recently been enjoyable only at specialty stores and also decreased in demand.

On the other hand, tuna is high in protein and low in fat and calories in terms of nutrients, and is analyzed as a food that makes a brain healthy because it is particularly rich in eicosapentaenoic acid (EPA) and docosahexaenoic acid (DHA). Accordingly, the tuna is expected to be highly marketable as a heathy food that can solve the shortcomings of instant foods such as meat hamburgers causing obesity in consumers and protect or improve health.

Further, the tuna has advantages in that it tastes mild and freshness is continuously maintained during distribution because the tuna is quickly frozen at −50° C. to −60° C. and stored as soon as it is caught, and characterized in \textcircled{1} anti-aging, cancer prevention: an abundance of nucleic acid (DHA), calcium, phosphorus, magnesium, selenium, etc., \textcircled{2} arteriosclerosis prevention: a large amount of EPA, \textcircled{3} obesity prevention: low calories, \textcircled{4} maintenance of metabolic balance: an abundance of vitamins, \textcircled{5} anemia prevention: a large amount of iron, \textcircled{6} glossy and elastic skin: high protein, low fat and low calories, etc.

Regarding the hamburger with the tuna, Korean Patent Publication No. 10-2016-0016319 (hereinafter, referred to as “prior art”) has proposed a method of manufacturing a tuna burger in which a patty is made with tuna instead of conventional pork or beef but has substantially the same texture as meat patties so that nutrients can be more balanced than the conventional ones and the possibility of adjust diseases or the like caused by meat can be minimized.

However, the burger manufactured including the tuna as the patty or the like has disadvantages in that the unique flavor or smell of tuna remains, there may be a fishy smell, and the texture cannot be guaranteed. Therefore, a conventional tuna burger has limitations in that it is a food for limited consumers, which is mainly sought by a specific group of enthusiasts, rather than a generalized favorite food that many consumers can mostly like.

### SUMMARY OF THE INVENTION

Accordingly, the disclosure is conceived to solve the foregoing problems, and an aspect of the disclosure is to provide a method of manufacturing marinated tuna for a tuna burger, in which tuna is covered or mixed with a marinating mixture for removing a fishy taste from the tuna and kept refrigerated, so that the unique flavor or smell and fishy taste of the tuner, which consumers do not like, can disappear while improving the texture of the tuna, thereby providing the tuna burger that the majority of ordinary consumers will like.

According to an embodiment of the disclosure, there is provided a method of manufacturing marinated tuna for a tuna burger, the method including: ripening tuna in a ripening liquid, mixing the ripened tuna with a marinating mixture to remove a fishy taste, and refrigerating the mixed tuna,

wherein the ripening liquid is prepared by mixing 80 to 120 parts by weight of milk and 1 to 3 parts by weight of salt, or by mixing 80 to 120 parts by weight of water, 7 to 12 parts by weight of beetroot and 1 to 3 parts by weight of salt, with respect to 100 parts by weight of tuna.

The marinating mixture may be prepared by including 0.2 to 0.4 parts by weight of garlic, 0.2 to 0.4 parts by weight of ginger, 0.08 to 0.15 parts by weight of pepper, 0.04 to 0.06 parts by weight of basil, 18 to 22 parts by weight of lard, 18 to 22 parts by weight of onion, 8 to 12 parts by weight of baguette, and 3 to 6 parts by weight of egg, with respect to 100 parts by weight of tuna.

### BRIEF DESCRIPTION OF THE DRAWINGS

The above and/or other aspects of the disclosure will become apparent and more readily appreciated from the following description of the exemplary embodiments, taken in conjunction with the accompanying drawings, in which:

FIG. 1 is a flowchart showing a method of manufacturing marinated tuna for a tuna burger according to a first embodiment of the disclosure,

FIG. 2 is a flowchart showing a method of manufacturing marinated tuna for a tuna burger according to a second embodiment of the disclosure,

FIGS. 3 and 4 show photographs for describing the method of manufacturing the marinated tuna for the tuna burger according to the first embodiment of the disclosure,

FIGS. 5 to 7 show photographs for describing the method of manufacturing the marinated tuna for the tuna burger according to the second embodiment of the disclosure, and

FIG. 8 shows photographs of finished tuna burgers with marinated tuna manufactured by the method of manufacturing the marinated tuna for the tuna burger according to the embodiments of the disclosure.

### DETAILED DESCRIPTION

Below, a method of manufacturing marinated tuna for a tuna burger according to exemplary embodiments of the disclosure will be described in detail.

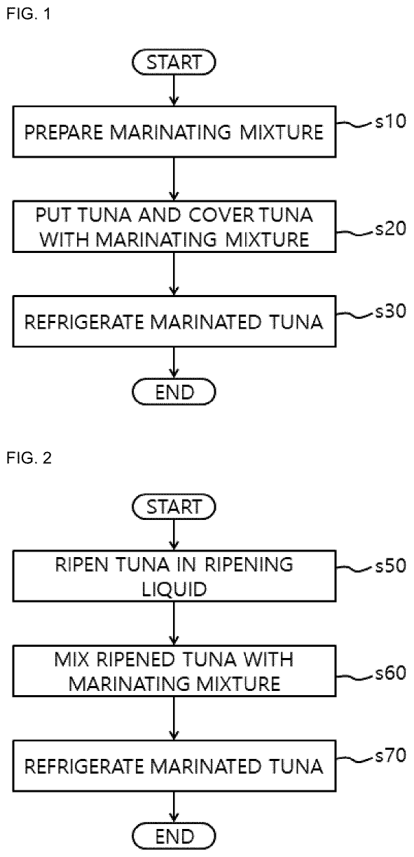

Referring to FIG. 1, a method of manufacturing marinated tuna for a tuna burger according to a first embodiment of the disclosure includes a method of manufacturing marinated tuna for a tuna burger, the method including the steps: of preparing a marinating mixture for removing a fishy taste from tuna (s10), putting the tuna in a container and covering the tuna with the marinating mixture (s20), and refrigerating the marinated tuna (s30).

### DETAILS OF EACH STEP ARE AS FOLLOWS.

1. The Step s10 of Preparing the Marinating Mixture

The marinated tuna for the tuna burger according to the first embodiment of the disclosure is manufactured using the marinating mixture prepared by mixing various ingredients. Therefore, the marinating mixture is first prepared.

The marinating mixture is provided to basically remove a fishy taste from the tuna that is the raw material for the marinated tuna. Further, the marinating mixture is provided to change the color, texture and appearance of the marinated tuna. In other words, the marinating mixture improves the ripening of the marinated tuna, removes the fishy taste to maximize the palatability of the taste, and provides various colors and appearances to expand the range of consumer choice.

According to the first embodiment of the disclosure, the marinating mixture is prepared by mixing 4 to 6 parts by weight of salt, 8 to 12 parts by weight of sugar, 1 to 3 parts by weight of basil, 20 to 30 parts by weight of orange, 8 to 15 parts by weight of lemon, and 7 to 12 parts by weight of beetroot, with respect to 100 parts by weight of tuna.

The salt and sugar are added for the fundamental tastes of the marinated tuna, and the orange, lemon, basil and beetroot are added for adding flavor to and removing a fishy taste from the marinated tuna. Besides, the beetroot is added for improving the color of the marinated tuna.

The orange and lemon may be added in a crushed or cut form. The orange and lemon are crushed with their rind and added in the form of orange juice and lemon juice. Here, the rind is added for multiplying the flavor of the marinated tuna flavored with the orange juice and lemon juice, and for multiplying the effect on removing the fishy taste. The basil is effective in removing the fishy taste and fishy smell from the marinated tuna.

The beetroot is added to make the color of the marinated tuna red, and 7 to 12 parts by weight of the beetroot are suitable for making an acceptable red color and making a color similar to the color of beef. In other words, if the beetroot is added more than such proportions, the red color of the marinated tuna becomes too dark and is repulsive, thereby causing a problem of reducing the appetite. On the other hand, if the beetroot is added less than the proportions, the red color becomes too light and is dissimilar to the color of beef, thereby causing a problem that there is a limit to the appetite stimulation for consumers. Therefore, it is preferable that 7 to 12 parts by weight of the beetroot are added with respect to 100 parts by weight of the tuna.

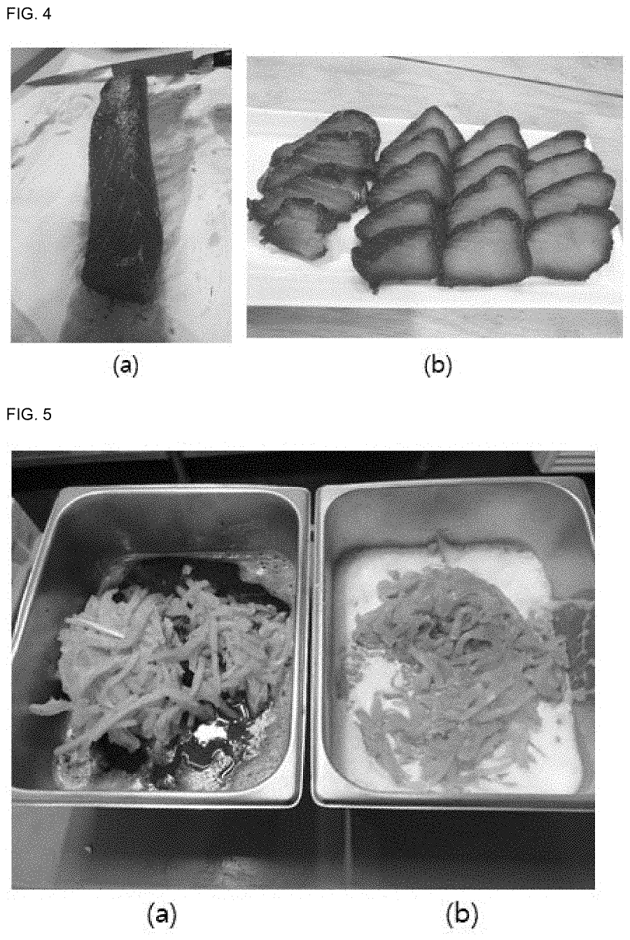

The marinated tuna (hereinafter, referred to as “first marinated tuna”, shown in FIG. 4), which is manufactured in such a way that tuna is marinated in the marinating mixture prepared by mixing the foregoing proportions of ingredients and then refrigerated for a certain period of time, has a basic color and a basic texture.

2. The Step s20 of Putting the Tuna and Covering the Tuna With the Marinating Mixture

After the marinating mixture for removing the fishy taste from the tuna is prepared in the step of preparing the marinating mixture, the tuna is put in the container and then covered with the marinating mixture for the marination of the tuna.

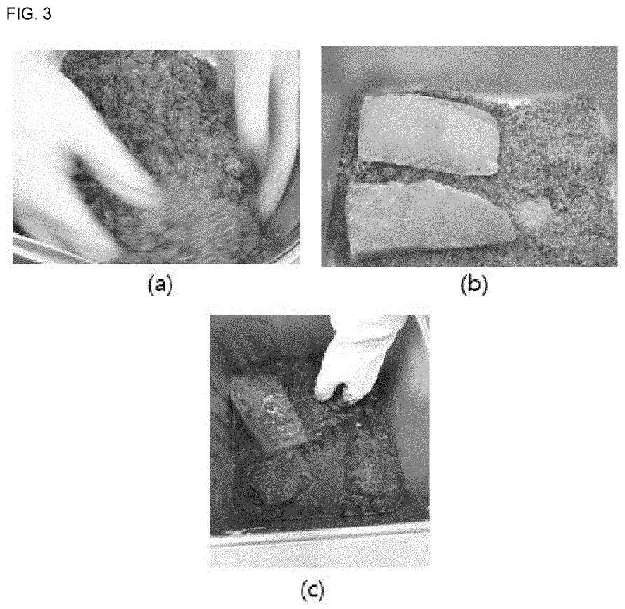

The tuna to be put in the container may be provided in the form of a patty, a steak, or a lump. In other words, the tuna to be put in the container may be given in a single lump that is not cut to a predetermined size, in the form of a patty having a predetermined size, or in the form of a steak (see FIG. 3) cut to a predetermined size.

When the tuna is given in the form of a lump, the lump of tuna is put in the container and then covered with the marinating mixture so as to uniformly coat the lump of tuna with the lump of tuna. On the other hand, when the tuna is given in the form of a patty or steak, a plurality of tuna layers are stacked as shown in FIG. 3 in such a manner that the marinating mixture is put on the bottom of the container, the tuna is put on the marinating mixture, and the marinating mixture covers the tuna. In other words, when the tuna is given in the form of a patty or steak, the plurality of tuna layers are stacked with the marinating mixture between the upper and lower portions of the tuna in the container.

3. The Step s30 of Refrigerating the Tuna.

After the step of putting the tuna in the container and covering the tuna with the marinating mixture is completed, the step of refrigerating the tuna in the container is carried out.

The refrigerating step is performed to heighten the marinating and ripening effects on the tuna put in the container. To this end, the container filled with the tuna and the marinating mixture may be kept refrigerated for 12 hours to 48 hours. If the container is refrigerated longer than such a keeping time, excessively ripens and becomes too mushy and watery, thereby deteriorating the texture. On the other hand, if the container is refrigerated shorter than the keeping time, the marinated tuna is not fully ripe having a weak flavor and is not tender.

When the container filled with the tuna and the marinating mixture is refrigerated for the foregoing period of time, the marinated tuna according to the first embodiment of the disclosure is finished as shown in FIG. 4.

However, consumers may prefer that the texture of the marinated tuna in the tuna burger is milder and softer, may separately prefer various colors such as the red color corresponding to the color of beef, and may prefer that the tuna burger includes the marinated tuna with seasoning.

To this end, a method of manufacturing marinated tuna for a tuna burger according to a second embodiment of the disclosure will be described with reference to FIG. 2.

The method of manufacturing the marinated tuna for the tuna burger according to the second embodiment of the disclosure includes a method of manufacturing marinated tuna for a tuna burger, the method including the steps of ripening tuna in a ripening liquid (s50), mixing the ripened tuna with a marinating mixture to remove a fishy taste (s60), and refrigerating the marinated tuna (s70).

### DETAILS OF EACH STEP ARE AS FOLLOWS.

1. The Step s50 of Ripening the Tuna

First, the step of ripening the tuna with the ripening liquid is carried out.

The marinated tuna for the tuna burger according to the second embodiment of the disclosure is manufactured by ripening and then mixing with the marinating mixture corresponding to a seasoning mixture. In other words, the marinated tuna manufactured according to the second embodiment of the disclosure is manufactured by the ripening and mixing steps, in which the tuna cut or crushed to a predetermined size rather than a lump of tuna may be used for better ripening and mixing.

In other words, the tuna cut or crushed to a predetermined size undergoes the ripening step using the ripening liquid as shown in FIG. 5. Specifically, the tuna cut or crushed to a predetermined size is put in a container filled with the ripening liquid and then ripened for a certain period of time.

The ripening liquid used in the ripening step is prepared using milk or beetroot as a main raw material. Specifically, the ripening liquid is prepared by mixing 80 to 120 parts by weight of milk and 1 to 3 parts by weight of salt, or by mixing 80 to 120 parts by weight of water, 7 to 12 parts by weight of beetroot and 1 to 3 parts by weight of salt, with respect to 100 parts by weight of tuna.

In FIG. 5, (b) shows that the cut or crushed tuna is ripened as being soaked in the ripening liquid prepared by mixing 80 to 120 parts by weight of milk and 1 to 3 parts by weight of salt, with respect to 100 parts by weight of the tuna. In the ripening step using the milk as the main raw material, the crushed or cut tuna is ripened as being soaked in the ripening liquid for 2 hours to 4 hours.

In FIG. 5, (a) shows that the cut or crushed tuna is ripened as being soaked in the ripening liquid prepared by mixing 80 to 120 parts by weight of water, 7 to 12 parts by weight of beetroot and 1 to 3 parts by weight of salt, with respect to 100 parts by weight of tuna. In the ripening step using the beetroot as the main raw material, the crushed or cut tuna is ripened as being soaked in the ripening liquid for 2 hours to 4 hours. Here, the beetroot may be juiced or ground to be mixed in the form of liquid.

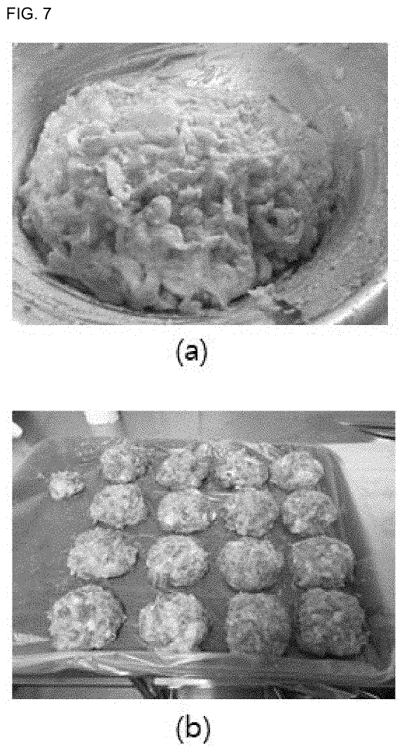

The ripening liquid, which is prepared by mixing 80 to 120 parts by weight of milk and 1 to 3 parts by weight of salt with respect to 100 parts by weight of the tuna, makes the tuna milder and softer. In other words, the milk is included as the main raw material in the ripening liquid to make the tuna milder and softer. The marinated tuna (hereinafter, referred to as “second marinated tuna”, shown in FIG. 7), which is manufactured in such a way that tuna is ripened in the ripening liquid using the milk as the main raw material, and then the ripened tuna is marinated in the marinating mixture and then refrigerated for a certain period of time, has a milder and softer texture even though its color is slightly white.

The ripening liquid, which is prepared by mixing 80 to 120 parts by weight of water, 7 to 12 parts by weight of beetroot and 1 to 3 parts by weight of salt with respect to 100 parts by weight of tuna, makes the color of the tuna better. In other words, the beetroot is included as the main raw material in the ripening liquid to make the color of the tuna red. Specifically, the beetroot makes the color of the tuna better having a red color and a color similar to the color of beef. The marinated tuna (hereinafter, referred to as “third marinated tuna”, shown in FIG. 7), which is manufactured in such a way that tuna is ripened in the ripening liquid using the beetroot as the main raw material, and then the ripened tuna is marinated in the marinating mixture and then refrigerated for a certain period of time, has a red color and a color similar to the color of beef, thereby stimulating appetite of consumers.

2. The Step s60 of Mixing With a Marinating Mixture

After the tuna is ripened in the ripening liquid, the ripened tuna is mixed with the marinating mixture to remove a fishy taste from the ripened tuna. Here, the marinating mixture is used for not only removing the fishy taste from the ripened tuna but also multiplying the tastes of the ripened tuna and making the tuna palatable to consumers. In other words, the marinating mixture according to the second embodiment of the disclosure may include a seasoning mixture for improving the tastes of the ripened tuna and removing the fishy taste.

Here, the marinating mixture is prepared by including 0.2 to 0.4 parts by weight of garlic, 0.2 to 0.4 parts by weight of ginger, 0.08 to 0.15 parts by weight of pepper, 0.04 to 0.06 parts by weight of basil, 18 to 22 parts by weight of lard, 18 to 22 parts by weight of onion, 8 to 12 parts by weight of baguette, and 3 to 6 parts by weight of egg, with respect to 100 parts by weight of tuna. In other words, the ripened tuna and the foregoing proportions of ingredients are put together in the container and then mixed to season the ripened tuna.

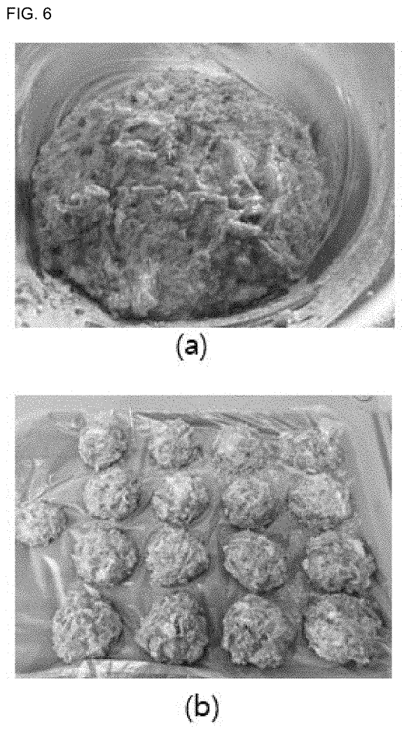

In FIG. 7, (a) shows the second marinated tuna mixed with the marinating mixture. In FIG. 6, (a) shows the third marinated tuna mixed with the marinating mixture.

3. The Step s70 of Refrigerating the Marinated Tuna

After the ripened tuna is put in the container and mixed with the marinating mixture, the mixed tuna is kept refrigerated for a certain period of time. The tuna mixed with the marinating mixture may be refrigerated as it is put in the container, or may be refrigerated after being formed to have a size and shape for the tuna burger. In FIG. 7, (b) shows the second marinated tuna mixed and formed to have a certain size and shape. In FIG. 6, (b) shows the third marinated tuna mixed and formed to have a certain size and shape.

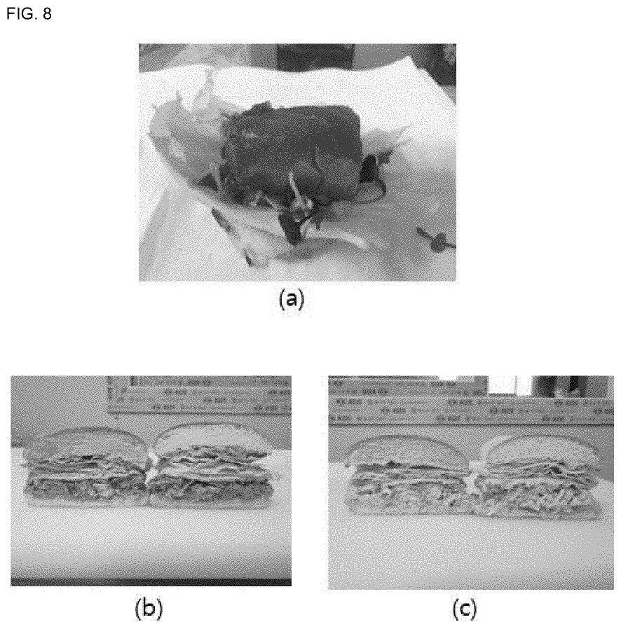

In FIG. 8, (a) illustrates that the first marinated tuna shaped like a steak and various ingredients such as cabbage, lettuce, etc. are put together on a piece of bread and a sauce is put thereon to make the tuna burger, (b) illustrates that the third marinated tuna shaped like a grilled patty and various ingredients such as cabbage, lettuce, etc. are put together on a piece of bread and a sauce is put thereon to make the tuna burger, and (c) illustrates that the second marinated tuna shaped like a grilled patty and various ingredients such as cabbage, lettuce, etc. are put together on a piece of bread and a sauce is put thereon to make the tuna burger.

Below, embodiments of the method of manufacturing the marinated tuna for the tuna burger according to the disclosure and the method of making the tuna burger including the same method will be described. However, the embodiments set forth herein are merely to describe the details of the disclosure, and do not limit the scope of the disclosure.

### (EMBODIMENT_1)

The marinated tuna was manufactured by marinating 1 kg of tuna in the marinating mixture, in which the marinating mixture was prepared by mixing 50 g of salt, 100 g of sugar, 110 g of lemon, 240 g of orange, 90 g of beetroot and 20 g of basil 20 g. 1 kg of the tuna was prepared in the form of 10 steaks each weighing 100 g. The 10 pieces of steak-type tuna were stacked with the marinating mixture between the lower and upper sides of the steak-type tuna in the container. Then, the container filled with the tuna and the marinating mixture was kept refrigerated for 24 hours, thereby manufacturing the marinated tuna. Thus, the tuna burger was made with the steak-type marinated tuna prepared as above. In other words, the first marinated tuna given in the form of a non-grilled steak and various ingredients such as cabbage, lettuce, etc. were put together on a piece of bread and a sauce was put thereon to make the tuna burger.

### (EMBODIMENT_2)

First, 1 kg of tuna was soaked in the ripening liquid prepared by mixing 1 L of milk and 20 g of salt and ripened for 3 hours. Then, the ripened tuna was mixed with the marinating mixture to manufacture the marinated tuna, in which the marinating mixture was prepared by mixing 3 g of garlic powder, 3 g of ginger powder, 1 g of pepper powder, 0.5 g of basil, 200 g of lard, 200 g of onion, 100 g of baguette and 50 g of egg with respect to 1 kg of the ripened tuna. Here, the tuna was ripened and mixed in a cut or crushed form. Then, the tuna mixed with the marinating mixture was kept refrigerated for 24 hours to manufacture the marinated tuna. Thus, the tuna burger was made with the patty-type marinated tuna prepared as above. In other words, the second marinated tuna given in the form of a grilled patty and various ingredients such as cabbage, lettuce, etc. were put together on a piece of bread and a sauce was put thereon to make the tuna burger.

### (EMBODIMENT_3)

First, 1 kg of tuna was soaked in the ripening liquid prepared by mixing 1 L of water, 20 g of salt and 90 g of beetroot, and ripened for 3 hours. Then, the ripened tuna was mixed with the marinating mixture to manufacture the marinated tuna, in which the marinating mixture was prepared by mixing 3 g of garlic powder, 3 g of ginger powder, 1 g of pepper powder, 0.5 g of basil, 200 g of lard, 200 g of onion, 100 g of baguette and 50 g of egg with respect to 1 kg of the ripened tuna. Here, the tuna was ripened and mixed in a cut or crushed form. Then, the tuna mixed with the marinating mixture was kept refrigerated for 24 hours to manufacture the marinated tuna. Thus, the tuna burger was made with the patty-type marinated tuna prepared as above. In other words, the third marinated tuna given in the form of a grilled patty and various ingredients such as cabbage, lettuce, etc. were put together on a piece of bread and a sauce was put thereon to make the tuna burger.

### (COMPARATIVE EXAMPLE_1)

In relation to the process of manufacturing the marinated tuna, the comparative example_1 is the same as the embodiment_1 except that the marinated tuna of the embodiment_1 is prepared as being marinated in the marinating mixture, which includes only 50 g of salt and 100 g of sugar, at room temperature for 3 hours without being kept refrigerated. Thus, the tuna burger was made with the steak-type marinated tuna prepared as above. In other words, the marinated tuna given in the form of the steak and various ingredients such as cabbage, lettuce, etc. were put together on a piece of bread and a sauce was put thereon to make the tuna burger.

### (COMPARATIVE EXAMPLE_2)

In relation to the process of manufacturing the marinated tuna, the comparative example_2 is the same as the embodiments_2 and _3 except that the marinated tuna of the embodiments_2 and _3 is not previously ripened but prepared as being marinated in the marinating mixture, which includes only 50 g of salt, 100 g of sugar and 1 g of pepper, at room temperature for 3 hours without being kept refrigerated. Thus, the tuna burger was made with the grilled patty-type marinated tuna prepared as above. In other words, the prepared marinated tuna was grilled in the form of a patty, and then the grilled-patty type marinated tuna and various ingredients such as cabbage, lettuce, etc. were put together on a piece of bread and a sauce was put thereon to make the tuna burger.

<Sensory Test>

A sensory test was carried out by tasting the tuna burgers with the marinated tuna according to the embodiments_1 to _3 and the comparative examples_1 and _2. 30 panelists were selected to evaluate the tuna burgers based on the five-point scale with respect to appearance, texture, taste, and palatability, and the results were tabulated as shown in the following Table 1. The tuna burgers according to the embodiments_1 to _3 and the comparative examples_1 and _2 were cut in half to show their contents.

TABLE 1

| | | | | Overall |
|---|---|---|---|---|
| Classification | appearance | texture | taste | palatability |
| Embodiment_1 | 4.2 | 4.5 | 4.4 | 4.4 |
| Embodiment_2 | 4.0 | 4.8 | 4.6 | 4.5 |
| Embodiment_3 | 4.7 | 4.5 | 4.5 | 4.6 |
| Comparative | 3.5 | 3.5 | 2.5 | 3.2 |
| example_1 | | | | |
| Comparative | 3.8 | 4.0 | 3.5 | 3.8 |
| example_2 | | | | |

As results of the sensory test, the embodiment_1 scored high points in all of the appearance, texture and taste, and was thus relatively excellent in palatability. Therefore, it is determined that overall scores were high because of no fishy taste, relatively good texture with well ripening, and characteristic color based on marination.

Further, the embodiment_2 scored lower points in the appearance but higher points in the texture and taste than those of the embodiment_1, and also scored higher points in the overall palatability. Therefore, it is determined that higher points were given to the texture and taste because addition of milk made the marinated tuna milder and softer and the marinating mixture, i.e., the seasoning mixture was used, but the appearance was less good because whitishness is caused by the milk.

Further, the embodiment_3 scored much higher points in the appearance, also scored significantly higher points in the texture and taste than the embodiments_1 and _2, and thus scored the highest points in the overall palatability. Therefore, it is determined that the appearance stimulated appetite because the beetroot made a color similar to the color of beef, and the taste and texture were considerably good due to the beetroot.

On the other hand, the tuna burger manufactured by the comparative examples_1 and _2 scored much lower points in the appearance, texture and taste than those of the foregoing embodiments. Therefore, it is determined that lower points were given to the texture and taste because only salt and sugar or only salt, sugar and pepper are used in making tastes without removing the unique smell of tuna, i.e., the fishy taste, and ripening was not performed without refrigeration for an appropriate period of time.

Therefore, the tuna burgers manufactured by the embodiments_1 to _3 were very excellent in the appearance, taste and texture as compared to those of the comparative examples_1 and _2. Accordingly, it is expected that the tuna burger manufactured according to the disclosure are excellent in the tastes and palatability.

By a method of manufacturing marinated tuna for a tuna burger according to the disclosure with the foregoing aspects and solutions, tuna is covered or mixed with a marinating mixture for removing a fishy taste from the tuna and kept refrigerated, so that the unique flavor or smell and fishy taste of the tuner, which consumers do not like, can disappear while improving the texture of the tuna, thereby providing the tuna burger that the majority of ordinary consumers will like.

Although a few exemplary embodiments of the disclosure have been described, these are for illustrative purpose only and it will be appreciated by those skilled in the art that various changes and equivalents may be made in these embodiments. Therefore, the scope of the disclosure for technical protection is defined by the appended claims.

What is claimed is:

1. A method of manufacturing marinated tuna for a tuna burger, the method comprising: ripening tuna in a ripening liquid, mixing the ripened tuna with a marinating mixture to remove a fishy taste, and refrigerating the mixed tuna,
wherein the ripening liquid is prepared by mixing 80 to 120 parts by weight of milk and 1 to 3 parts by weight of salt, or by mixing 80 to 120 parts by weight of water, 7 to 12 parts by weight of beetroot and 1 to 3 parts by weight of salt, with respect to 100 parts by weight of tuna.

2. The method of claim 1, wherein the marinating mixture is prepared by comprising 0.2 to 0.4 parts by weight of garlic, 0.2 to 0.4 parts by weight of ginger, 0.08 to 0.15 parts by weight of pepper, 0.04 to 0.06 parts by weight of basil, 18 to 22 parts by weight of lard, 18 to 22 parts by weight of onion, 8 to 12 parts by weight of baguette, and 3 to 6 parts by weight of egg, with respect to 100 parts by weight of tuna.
